(19) United States
(12) Patent Application Publication
(10) Pub. No.: US 2016/0179532 A1
(43) Pub. Date: Jun. 23, 2016

(54) MANAGING ALLOCATION OF PHYSICAL REGISTERS IN A BLOCK-BASED INSTRUCTION SET ARCHITECTURE (ISA), AND RELATED APPARATUSES AND METHODS

(71) Applicant: QUALCOMM Incorporated, San Diego, CA (US)

(72) Inventor: Gregory Michael Wright, Chapel Hill, NC (US)

(21) Appl. No.: 14/578,913

(22) Filed: Dec. 22, 2014

(51) Int. Cl. G06F 9/30; G06F 12/08

(52) U.S. Cl. CPC G06F 9/30043; G06F 12/084; G06F 12/0875; G06F 2212/452; G06F 2212/314

(57) ABSTRACT

Managing allocation of physical registers in a block-based instruction set architecture (ISA), and related apparatuses and methods, are disclosed. In one aspect, an apparatus provides an instruction processing circuit communicatively coupled to multiple physical registers. The instruction processing circuit includes a register rename map that comprises an association between at least one architectural register and at least one of the multiple physical registers. The instruction processing circuit further comprises an in-use indicator set associated with the register rename map, the in-use indicator set indicative of an in-use physical register among the multiple physical registers. The instruction processing circuit is configured to copy the in-use indicator set to an output in-use indicator set, and modify the output in-use indicator set upon detection of a block-based write instruction to mark the in-use physical register as unused.

### BACKGROUND

I. Field of the Disclosure

The technology of the disclosure relates generally to register remapping in a block-based instruction set architecture (ISA).

II. Background

Register remapping, or register renaming, is a technique employed by many modern out-of-order (OOO) processors to improve parallelism of instruction execution. The instruction set architecture (ISA) of such a processor may specify a limited set of registers, referred to herein as “architectural registers,” that may be read from and written to by instructions being executed by the processor. The values that are apparently read from and written to the architectural registers by the instructions are actually stored in physically separate locations (“physical registers”) provided by the processor.

In a conventional OOO processor, instructions may be fetched individually for execution. As the processor determines that an instruction will write to an architectural register, the processor allocates a physical register to the architectural register. The physical register may then store a value associated with the architectural register. Allocation of physical registers may be tracked using a register rename map, which maps each architectural register in use to its corresponding physical register. When an architectural register in which a value is stored is written to again by an instruction, a new physical register is allocated to the architectural register, and the register rename map is later updated to reclaim the previous physical register by marking it as unallocated. By employing register remapping, a processor may detect and avoid unnecessary dependencies between instructions that may arise due to reuse of architectural registers, which may result in improved parallelism. Register remapping may also allow for more efficient use of physical registers in ISA implementations in which there are more physical registers than architectural registers.

In a conventional OOO processor, physical register allocation may be managed using two rename maps: a first register rename map at the beginning of an execution pipeline, and a second register rename map at the end of the execution pipeline. The first register rename map is updated as instructions are fetched, and thus indicates a state of the register rename map as it would appear to the fetched instructions. The second register rename map is updated as instructions are committed, and therefore indicates a state of the register rename map as it looks to committed instructions. Physical registers are deallocated as instructions are committed. Because a conventional OOO processor commits a relatively small number of instructions in each processor cycle, this incremental deallocation technique may provide efficient management of physical registers for the conventional OOO processor.

However, this technique for managing physical register allocation may result in suboptimal results when employed for register remapping by a block-based ISA. In contrast to conventional ISAs in which individual instructions are fetched, a block-based ISA may enable blocks of instructions (e.g., up to 128 instructions, in some aspects) to be fetched and processed as a unit, referred to as an “instruction block.” Each instruction block is processed atomically by the block-based ISA, such that either all instructions within the instruction block will be committed at the same time, or none of the instructions will be committed. As a result, using the deallocation approach of a conventional OOO processor requires a relatively large number of physical registers to be deallocated in a single processor cycle by a processor executing the block-based ISA. This approach may prove prohibitively expensive in terms of processor size, performance, and/or power consumption.

### SUMMARY OF THE DISCLOSURE

Aspects disclosed in the detailed description include managing allocation of physical registers in a block-based instruction set architecture (ISA). Related apparatuses and methods are also provided. In one aspect, an apparatus provides an instruction processing circuit that is communicatively coupled to a plurality of physical registers. The instruction processing circuit comprises in-use indicator sets associated with register rename maps of corresponding instruction blocks, with the in-use indicator sets indicative of in-use physical registers. For each instruction block, the instruction processing circuit, in some exemplary aspects, copies an in-use indicator set of a register rename map as an output in-use indicator set. When the instruction processing circuit detects a write instruction writing to an architectural register within the instruction block, the instruction processing circuit determines a previous physical register associated with the architectural register based on the register rename map. The instruction processing circuit then modifies an indicator corresponding to the previous physical register in the output in-use indicator set to indicate that the previous physical register is unused. Some aspects may provide that the instruction processing circuit also modifies an indicator in the output in-use indicator set of subsequent instruction blocks to indicate that the previous physical register is unused. In some aspects, the instruction processing circuit additionally allocates a physical register of the plurality of physical registers to the architectural register based on the output in-use indicator set. The instruction processing circuit may then modify an indicator corresponding to the allocated physical register in the output in-use indicator set to indicate that the allocated physical register is in use.

In another aspect, an apparatus comprising an instruction processing circuit is provided. The instruction processing circuit is communicatively coupled to a plurality of physical registers. The instruction processing circuit comprises a register rename map of an instruction block, comprising an association between at least one architectural register and at least one of the plurality of physical registers. The instruction processing circuit further comprises an in-use indicator set associated with the register rename map, the in-use indicator set indicative of an in-use physical register among the plurality of physical registers. The instruction processing circuit is configured to copy the in-use indicator set as an output in-use indicator set, and modify the output in-use indicator set upon detection of a block-based write instruction within the instruction block to mark the in-use physical register as unused.

In another aspect, an apparatus comprising an instruction processing circuit is provided. The instruction processing circuit comprises a means for copying an in-use indicator set of a register rename map of an instruction block as an output in-use indicator set, the in-use indicator set indicative of an in-use physical register among a plurality of physical registers. The apparatus further comprises a means for modifying the output in-use indicator set upon detection of a block-based write instruction within the instruction block to mark the in-use physical register as unused.

In another aspect, a method for managing allocation of physical registers in a block-based instruction set architecture is provided. The method comprises copying an in-use indicator set of a register rename map of an instruction block as an output in-use indicator set, the in-use indicator set indicative of an in-use physical register among a plurality of physical registers. The method further comprises modifying the output in-use indicator set upon detection of a block-based write instruction within the instruction block to mark the in-use physical register as unused.

### BRIEF DESCRIPTION OF THE FIGURES

FIG. 1 is a block diagram of an exemplary block-based computer processor core implementing a block-based instruction set architecture (ISA) and including an instruction processing circuit for managing physical register allocation for instruction blocks;

FIG. 2 is a block diagram illustrating relationships between register rename maps and in-use indicator sets for a sequence of instruction blocks processed by the instruction processing circuit of FIG. 1;

FIGS. 3A-3C are diagrams illustrating exemplary communications flows for the instruction processing circuit of FIG. 1 for creating an output in-use indicator set and updating the output in-use indicator set in response to a block-based write instruction in an instruction block;

FIG. 4 is a flowchart illustrating an exemplary process for managing physical register allocation in a block-based ISA;

FIGS. 5A-5D are diagrams illustrating further exemplary communications flows for the instruction processing circuit of FIG. 1 for creating and updating an output register rename map in conjunction with an in-use indicator set;

FIGS. 6A-6D are flowcharts illustrating further exemplary operations for managing physical register allocation using an output in-use indicator set and an output register rename map; and

FIG. 7 is a block diagram of an exemplary processor-based system that can include the instruction processing circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include managing allocation of physical registers in a block-based instruction set architecture (ISA). Related apparatuses and methods are also provided. In one aspect, an apparatus provides an instruction processing circuit that is communicatively coupled to a plurality of physical registers. The instruction processing circuit comprises in-use indicator sets associated with register rename maps of corresponding instruction blocks, with the in-use indicator sets indicative of in-use physical registers. For each instruction block, the instruction processing circuit, in some exemplary aspects, copies an in-use indicator set of a register rename map as an output in-use indicator set. When the instruction processing circuit detects a write instruction writing to an architectural register within the instruction block, the instruction processing circuit determines a previous physical register associated with the architectural register based on the register rename map. The instruction processing circuit then modifies an indicator corresponding to the previous physical register in the output in-use indicator set to indicate that the previous physical register is unused. Some aspects may provide that the instruction processing circuit also modifies an indicator in the output in-use indicator set of subsequent instruction blocks to indicate that the previous physical register is unused. In some aspects, the instruction processing circuit additionally allocates a physical register of the plurality of physical registers to the architectural register based on the output in-use indicator set. The instruction processing circuit may then modify an indicator corresponding to the allocated physical register in the output in-use indicator set to indicate that the allocated physical register is in use.

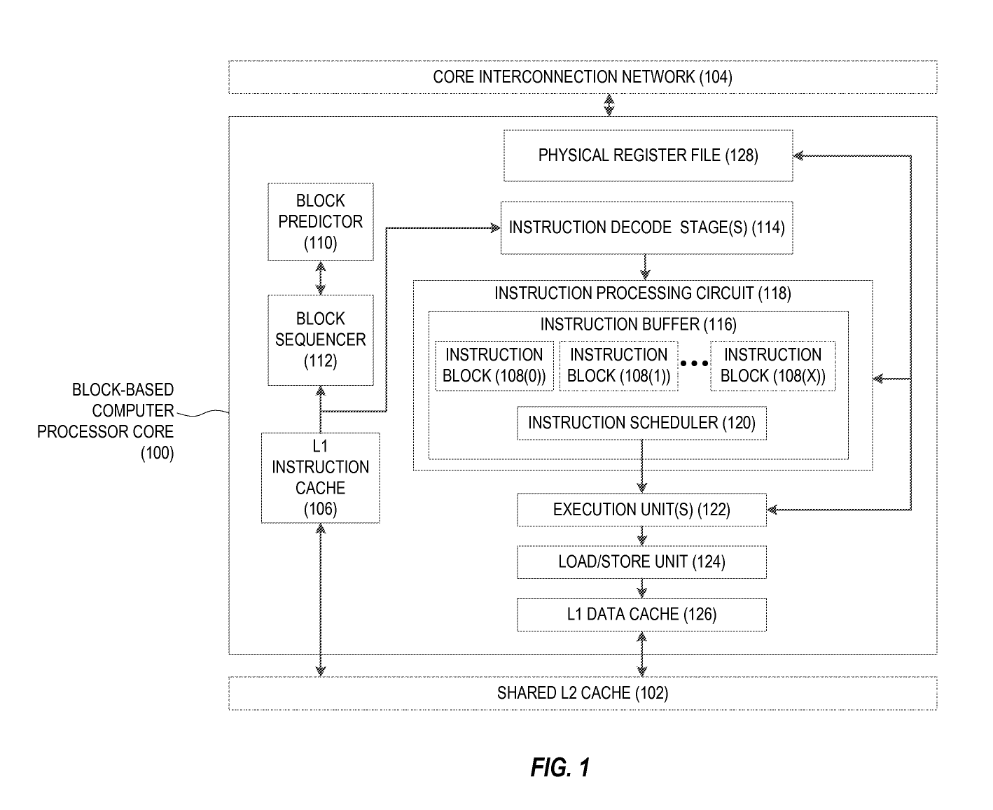

Before discussing an instruction processing circuit for managing register remapping in a block-based ISA, exemplary elements and operation of a block-based computer processor core are described. In this regard, FIG. 1 illustrates an exemplary block-based computer processor core 100 that is based on a block-based ISA, and that is configured to execute a sequence of instruction blocks. In some aspects, the block-based computer processor core 100 may be one of multiple block-based computer processor cores (not shown), each executing separate sequences of instruction blocks and/or coordinating to execute a single sequence of instruction blocks. The block-based computer processor core 100 may access a shared Level 2 (L2) cache 102 for receiving instruction blocks for execution and/or for storing data resulting from instruction block execution. In aspects comprising multiple block-based computer processor cores 100, a core interconnection network 104 may be employed for inter-core communications. The block-based computer processor core 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

In exemplary operation, a Level 1 (L1) instruction cache 106 of the block-based computer processor core 100 may receive instruction blocks (e.g., instruction blocks 108(0)-108(X)) for execution from the shared L2 cache 102. It is to be understood that, at any given time, the block-based computer processor core 100 may be processing more or fewer instruction blocks than the instruction blocks 108(0)-108(X) illustrated in FIG. 1. A block predictor 110 determines a predicted execution path of the instruction blocks 108(0)-108(X). In some aspects, the block predictor 110 may predict an execution path in a manner analogous to a branch predictor of a conventional out-of-order (OOO) processor. A block sequencer 112 orders the instruction blocks 108(0)-108(X), and forwards the instruction blocks 108(0)-108(X) to one of one or more instruction decode stage(s) 114 for decoding.

After decoding, the instruction blocks 108(0)-108(X) are held in an instruction buffer 116 of an instruction processing circuit 118 pending execution. An instruction scheduler 120 distributes instructions (not shown) of the active instruction blocks 108(0)-108(X) to one of one or more execution units 122 of the block-based computer processor core 100. As non-limiting examples, the one or more execution units 122 may comprise an arithmetic logic unit (ALU) and/or a floating-point unit. The one or more execution units 122 may provide results of instruction execution to a load/store unit 124, which in turn may store the execution results in an L1 data cache 126.

The one or more execution units 122 may additionally or alternatively store execution results in a physical register file 128. The physical register file 128, in some aspects, comprises multiple physical registers (not shown) that provide named physical storage locations for data values. Some aspects may provide that the physical register file 128 may be implemented by fast static Random Access Memory (RAM) having dedicated read and write ports, as a non-limiting example.

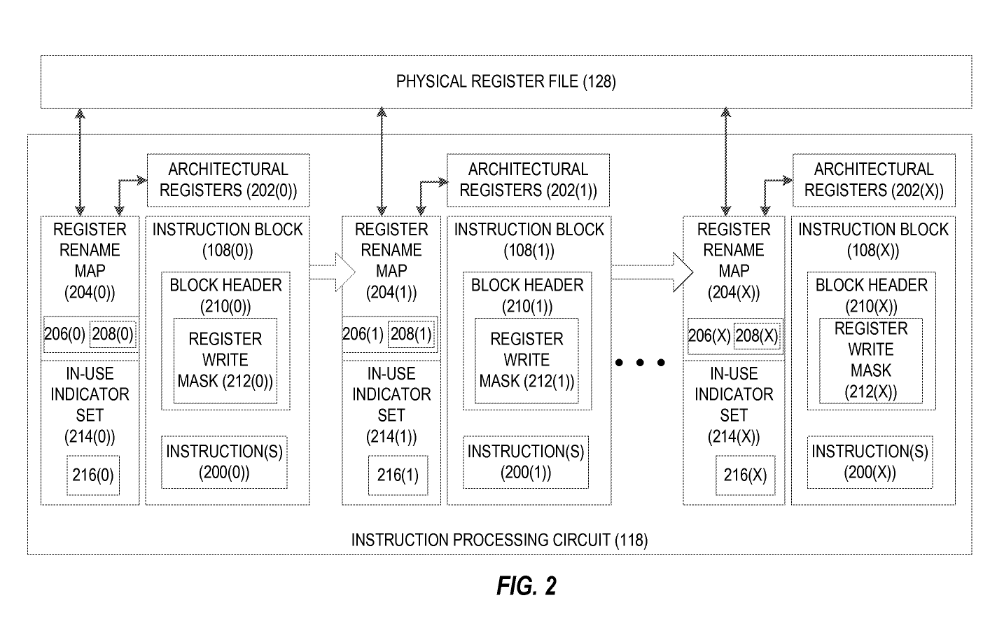

In order to detect and minimize data hazards and maximize parallelism, the block-based computer processor core 100 may provide register remapping functionality. Accordingly, to illustrate exemplary register renaming for the instruction blocks 108(0)-108(X) by the instruction processing circuit 118 of FIG. 1, FIG. 2 is provided. In FIG. 2, the instruction processing circuit 118 processes the sequence of instruction blocks 108(0)-108(X) of FIG. 1. In some aspects as disclosed herein, the instruction blocks 108(0)-108(X) may be processed concurrently by the instruction processing circuit 118. In aspects in which the block-based computer processor core 100 supports processing one of the instruction blocks 108(0)-108(X) at a time, the instruction blocks 108(0)-108(X) may be processed sequentially by the instruction processing circuit 118 over a period of time.

The instruction blocks 108(0)-108(X) include instructions 200(0)-200(X), respectively. During execution, each of the instruction blocks 108(0)-108(X) may read data values from and write data values to a corresponding set of architectural registers 202(0)-202(X) (e.g., general purpose registers, or GPRs) as directed by the respective instructions 200(0)-200(X). Using register remapping, the sets of architectural registers 202(0)-202(X) are mapped to physical registers (not shown) in the physical register file 128 of FIG. 1. The mapping between the sets of architectural registers 202(0)-202(X) and the physical registers in the physical register file 128 may be dynamically changed as values are written to the sets of architectural registers 202(0)-202(X) during execution of the instruction blocks 108(0)-108(X).

To track the allocation of physical registers in the physical register file 128 to the architectural registers 202(0)-202(X), the instruction blocks 108(0)-108(X) are associated with register rename maps 204(0)-204(X), respectively. The register rename maps 204(0)-204(X) each contain one or more entries 206(0)-206(X) that represent the mappings of the sets of architectural registers 202(0)-202(X) to physical registers before and/or after each instruction block 108(0)-108(X) executes on the block-based computer processor core 100. In some aspects, the one or more entries 206(0)-206(X) include respective present indicators 208(0)-208(X), which indicate whether the mapping is valid and available for use. In the example of FIG. 2, the register rename map 204(0) represents the least speculative mappings of the architectural register 202(0) for the block-based computer processor core 100, and is provided as input into the instruction block 108(0). The register rename map 204(1) may be generated as output by the instruction block 108(0) and provided as input to the instruction block 108(1), and may reflect the updates made within the instruction block 108(0). Similarly, the register rename map 204(1) may be generated as output by the instruction block 108(1) and provided as input to the instruction block 108(X), and may reflect the updates made within the instruction block 108(1). Accordingly, the register rename map 204(1) may be referred to herein as the “output register rename map 204(1)” with respect to the instruction block 108(0), and the register rename map 204(X) may be referred to herein as the “output register rename map 204(X)” with respect to the instruction block 108(1). According to some aspects as disclosed herein, the register rename maps 204(0)-204(X) may be stored in RAM, as a non-limiting example.

Each of the instruction blocks 108(0)-108(X) is further associated with a block header 210(0)-210(X), respectively. In the example of FIG. 2, the block headers 210(0)-210(X) provide respective register write masks 212(0)-212(X) that indicate which of the architectural registers 202(0)-202(X) will be written to by the corresponding instruction block 108(0)-108(X). It is to be understood that some aspects may provide that the register write masks 212(0)-212(X) may be generated or computed within the processor core 100 by inspecting the instructions 200(0)-200(X) within the corresponding instruction block 108(0)-108(X). It is to be further understood that in some aspects the register write masks 212(0)-212(X) are not binding on the corresponding instruction blocks 108(0)-108(X). As a non-limiting example, an expected write to an architectural register 202(0)-202(X) may not occur within the corresponding instruction block 108(0)-108(X) as indicated by the respective register write mask 212(0)-212(X). This may result in the architectural register 202(0)-202(X) retaining its previous value, referred to as “annulling” the expected write.

In the processing of the block-based ISA illustrated in FIG. 2, writes to the architectural registers 202(0)-202(X) are speculative until the corresponding instruction block 108(0)-108(X) commits Consequently, all of the writes performed by the instructions 200(0)-200(X) for a particular one of the corresponding instruction blocks 108(0)-108(X) are committed simultaneously. This may result in a larger number of simultaneous commits than an OOO processor for a conventional ISA may support.

In this regard, the instruction processing circuit 118 of FIG. 2 provides in-use indicator sets 214(0)-214(X) for managing physical register allocation. The in-use indicator sets 214(0)-214(X) are associated with the register rename maps 204(0)-204(X), respectively, for the corresponding instruction blocks 108(0)-108(X). Each of the in-use indicator sets 214(0)-214(X) includes one or more indicators 216(0)-216(X) for each physical register in the physical register file 128, which indicate whether the physical register is available for allocation. Rather than updating the entire in-use indicator sets 214(0)-214(X) when the associated instruction blocks 108(0)-108(X) commit, the instruction processing circuit 118 updates the in-use indicator sets 214(0)-214(X) incrementally as an instruction 200(0)-200(X) writes to a set of architectural registers 202(0)-202(X) within an instruction block 108(0)-108(X). In some aspects, the indicators 216(0)-216(X) may be set (i.e., assigned a value of “1”) to indicate that the corresponding physical register is in use, and may be cleared (i.e., assigned a value of “0”) to indicate that the corresponding physical register is available for allocation. According to some aspects as disclosed herein, the in-use indicator sets 214(0)-214(X) may be stored in Random Access Memory (RAM), as a non-limiting example. Some aspects may provide that the instruction processing circuit 118 may base allocations of new physical registers (not shown) for the set of architectural registers 202(0)-202(X) based on a logical OR of the in-use indicator sets 214(0)-214(X) for any in-progress instruction blocks 108(0)-108(X).

The in-use indicator sets 214(0)-214(X) may thus represent the state of physical register allocation before and/or after each instruction block 108(0)-108(X) executes on the block-based computer processor core 100. In the example of FIG. 2, the in-use indicator set 214(0) represents the least speculative state of physical register allocation, and is provided as input into the instruction block 108(0). The in-use indicator set 214(1) may be generated as output by the instruction block 108(0) and provided as input to the instruction block 108(1), and may reflect the updates made within the instruction block 108(0). Likewise, the in-use indicator set 214(2) may be generated as output by the instruction block 108(1) and provided as input to the instruction block 108(X), and may reflect the updates made within the instruction block 108(1). Consequently, the in-use indicator set 214(1) may be referred to herein as the “output in-use indicator set 214(1)” with respect to the instruction block 108(0), and the in-use indicator set 214(X) may be referred to herein as the “output in-use indicator set 214(X)” with respect to the instruction block 108(1).

According to some aspects disclosed herein, if one of the instruction blocks 108(0)-108(X) is successfully committed, the corresponding in-use indicator set 214(0)-214(X) is no longer considered as part of the logical-OR of all in-use indicator sets 214(0)-214(X) when allocating a new physical register. This functionality may be implemented in some aspects by masking out the appropriate in-use indicator sets 214(0)-214(X) when performing the logical OR operation, or by zeroing out the corresponding in-use indicator sets 214(0)-214(X), as non-limiting examples. Accordingly, a “commit” as described herein may be considered a point at which a physical register marked as in-use in the committed instruction block's 108(0)-108(X) corresponding in-use indicator set 214(0)-214(X) (and no other in-use indicator set 214(0)-214(X)) becomes available for allocation. It is to be understood that the instruction blocks 108(0)-108(X) may also be terminated by being flushed (e.g., as a result of a mis-speculation or an exception). In that case, the output in-use indicator set 214(0)-214(X) for the flushed instruction block 108(0)-108(X), and all subsequent in-use indicator set 214(0)-214(X), would also no longer be considered in allocating a new physical register.

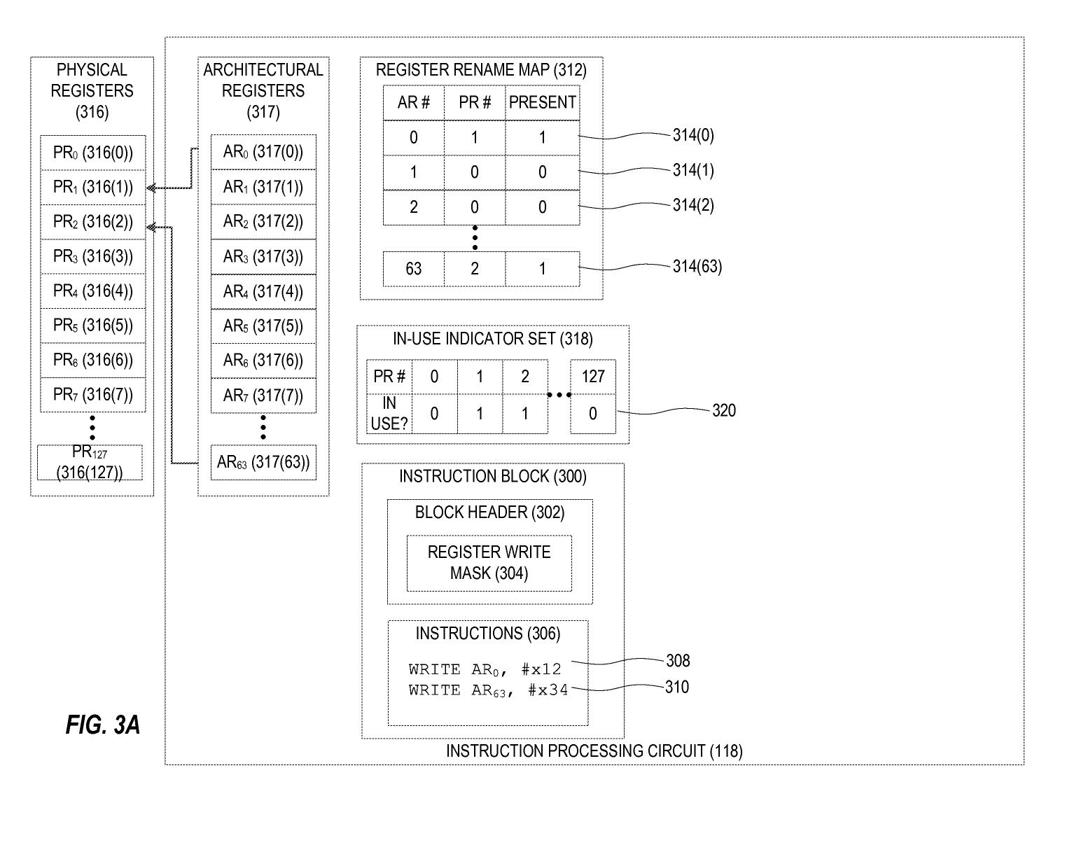

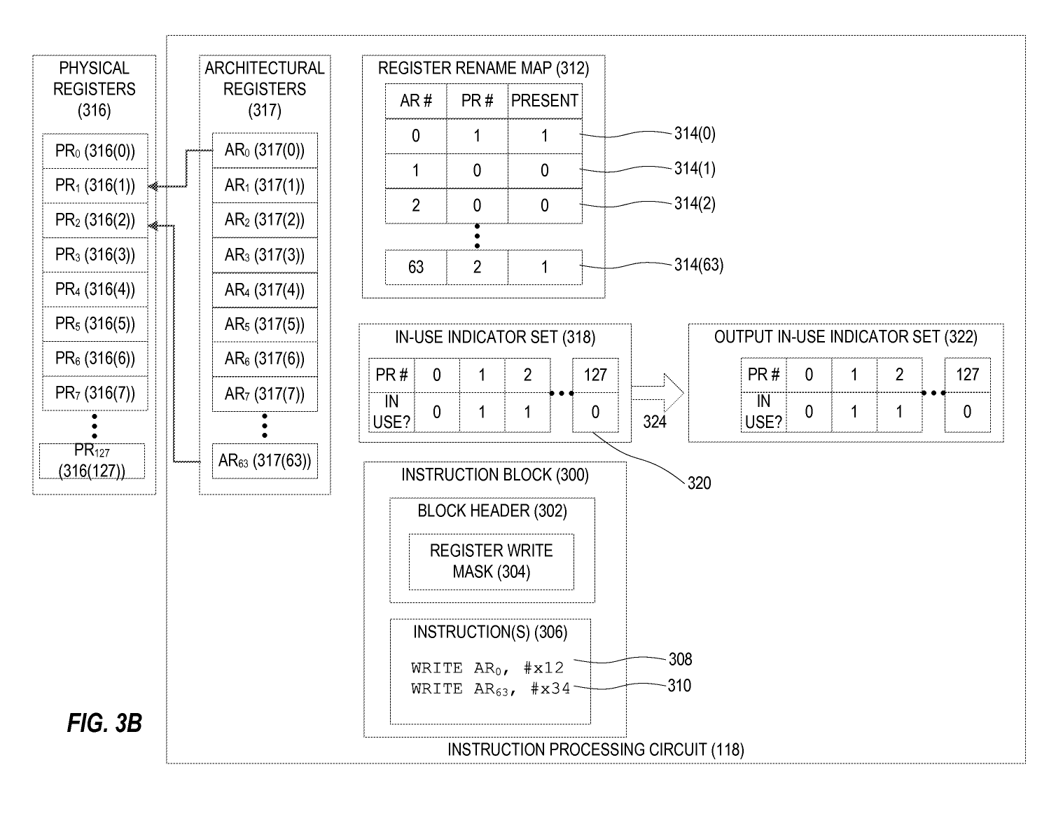

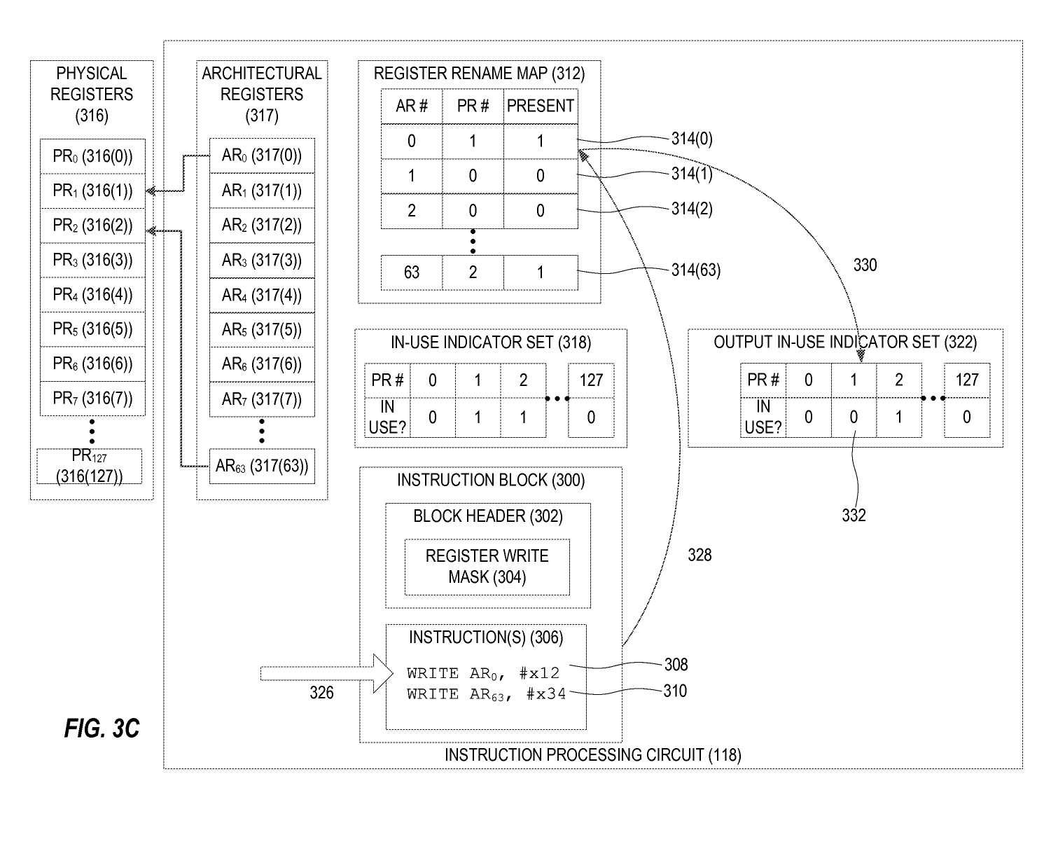

FIGS. 3A-3C provide an illustration of the use of in-use indicator sets (such as the in-use indicator sets 214(0)-214(X) of FIG. 2) by the instruction processing circuit 118 of FIGS. 1 and 2 to manage allocation of physical registers. In FIG. 3A, the instruction processing circuit 118 has fetched an instruction block 300, which corresponds to one of the instruction blocks 108(0)-108(X) of FIGS. 1 and 2, and which includes a block header 302 comprising a register write mask 304. Within the instruction block 300 are instructions 306. In this example, the instructions 306 include a WRITE instruction 308 and a WRITE instruction 310.

The instruction block 300 is associated with a register rename map 312 comprising entries 314(0)-314(63). Each of the entries 314(0)-314(63) includes an architectural register number (“AR #”), a physical register number (“PR #”), and a present bit (“PRESENT”). The physical register number for each of the entries 314(0)-314(63) indicates one of physical registers 316(0)-316(127) that is currently mapped to one of architectural registers 317(0)-317(63). The present bit of each of the entries 314(0)-314(63) indicates that the mapping is active and available for use. As seen in FIG. 3A, the entry 314(0) indicates that the architectural register 317(0) (“AR₀”) is presently mapped to physical register 316(1) (“PR₁”), while the entry 314(63) indicates that the architectural register 317(63) (“AR₆₃”) is presently mapped to physical register 316(2) (“PR₂”)

In the example of FIGS. 3A-3C, an in-use indicator set 318 is associated with the register rename map 312. The in-use indicator set 318 provides a bit set 320 that represents the current allocation state of the physical registers 316(0)-316(127). In the present example, the bit set 320 indicates that the physical registers PR₁ and PR₂ are presently allocated.

Referring now to FIG. 3B, processing of the instruction block 300 begins. The instruction processing circuit 118 copies the in-use indicator set 318 as an output in-use indicator set 322, as indicated by arrow 324. As discussed above with respect to FIG. 2, in some aspects the output in-use indicator set 322 may be provided later as input to an instruction block (not shown) subsequent to the instruction block 300.

In FIG. 3C, the instruction processing circuit 118 detects the WRITE instruction 308 that writes a hexadecimal value of 12 to architectural register 317(0) AR₀, as indicated by arrow 326. The instruction processing circuit 118 then queries the register rename map 312, as indicated by arrow 328, to determine a previous physical register 316(0)-316(127) associated with the architectural register 317(0) AR₀. In the example of FIG. 3C, the entry 314(0) of the register rename map 312 indicates that the previous physical register 316(0)-316(127) associated with the architectural register 317(0) AR₀ is the physical register 316(1) PR₁. Accordingly, as indicated by arrow 330, the instruction processing circuit 118 modifies an indicator 332 corresponding to the previous physical register 316(1) in the output in-use indicator set 322 to have a value of “0” to indicate that the previous physical register 316(1) is unused.

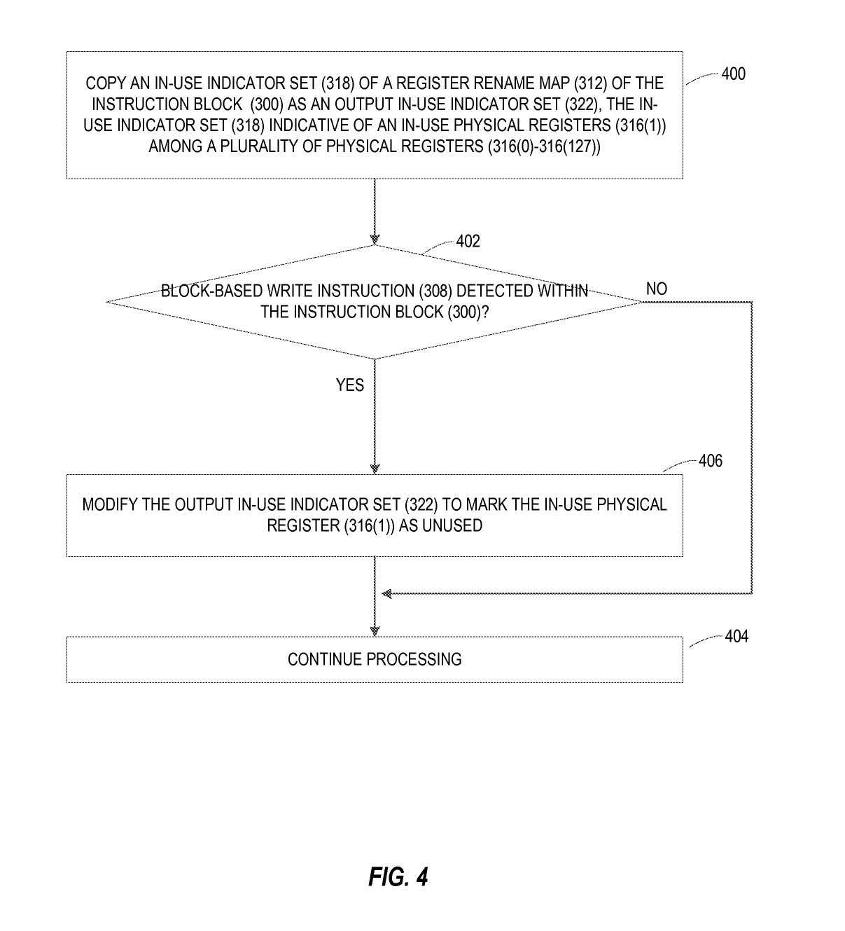

FIG. 4 is a flowchart illustrating an exemplary process for managing physical register allocation in a block-based ISA. In describing FIG. 4, elements of FIGS. 1 and 3A-3C are referenced for the sake of clarity. The instruction processing circuit 118 may carry out the following operations for each instruction block 300 of one or more instruction blocks 108(0)-108(X). Operations in FIG. 4 begin with the instruction processing circuit 118 copying an in-use indicator set 318 of a register rename map 312 of the instruction block 300 as an output in-use indicator set 322 (block 400). It is to be understood that the in-use indicator set 318 is indicative of one or more in-use physical registers 316(1), among a plurality of physical registers 316(0)-316(127).

The instruction processing circuit 118 next determines whether a block-based write instruction 308 has been detected within the instruction block 300 (block 402). If not, processing resumes at block 404. However, if the block-based write instruction 308 is detected within the instruction block 300, the instruction processing circuit 118 modifies the output in-use indicator set 322 to mark that the in-use physical register 316(1) as unused (block 406). Processing then continues at block 404. In this manner, the output in-use indicator set 322 is incrementally updated as write instructions 308, 310 are encountered within the instruction block 300. When the entire instruction block 300 is ready to be committed, the output in-use indicator set 322 will correctly indicate an updated allocation status for the physical registers 316(0)-316(127).

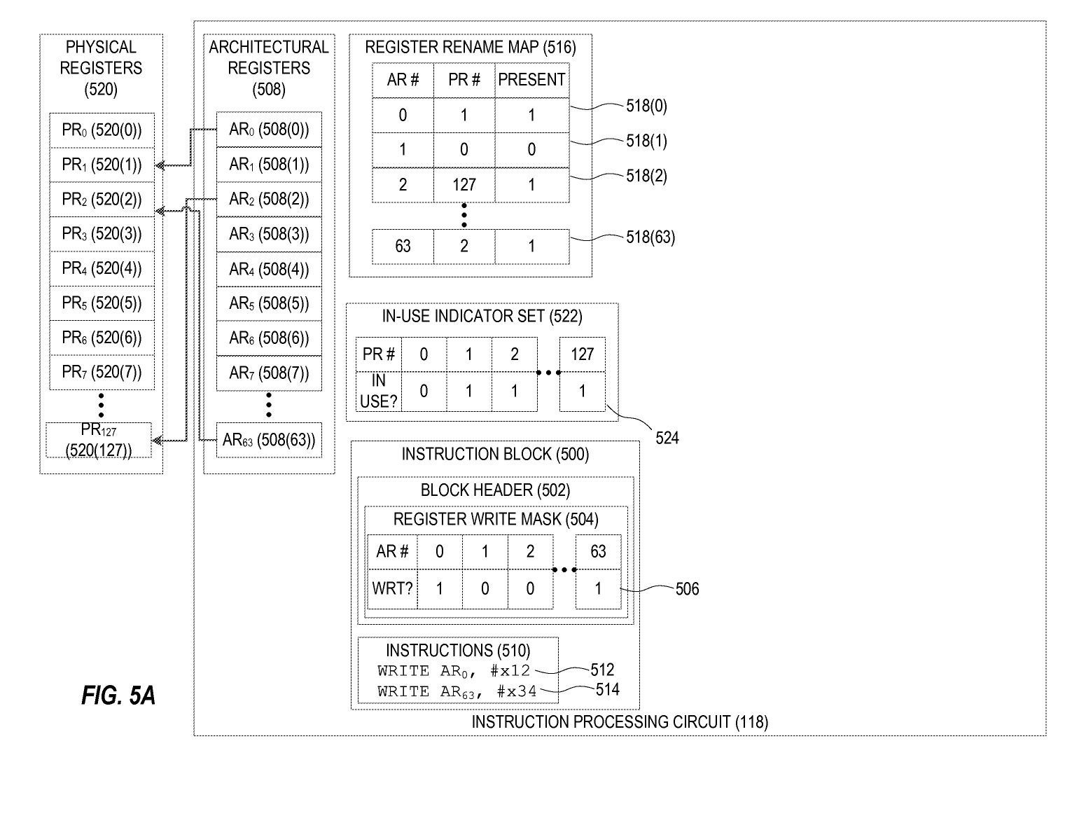

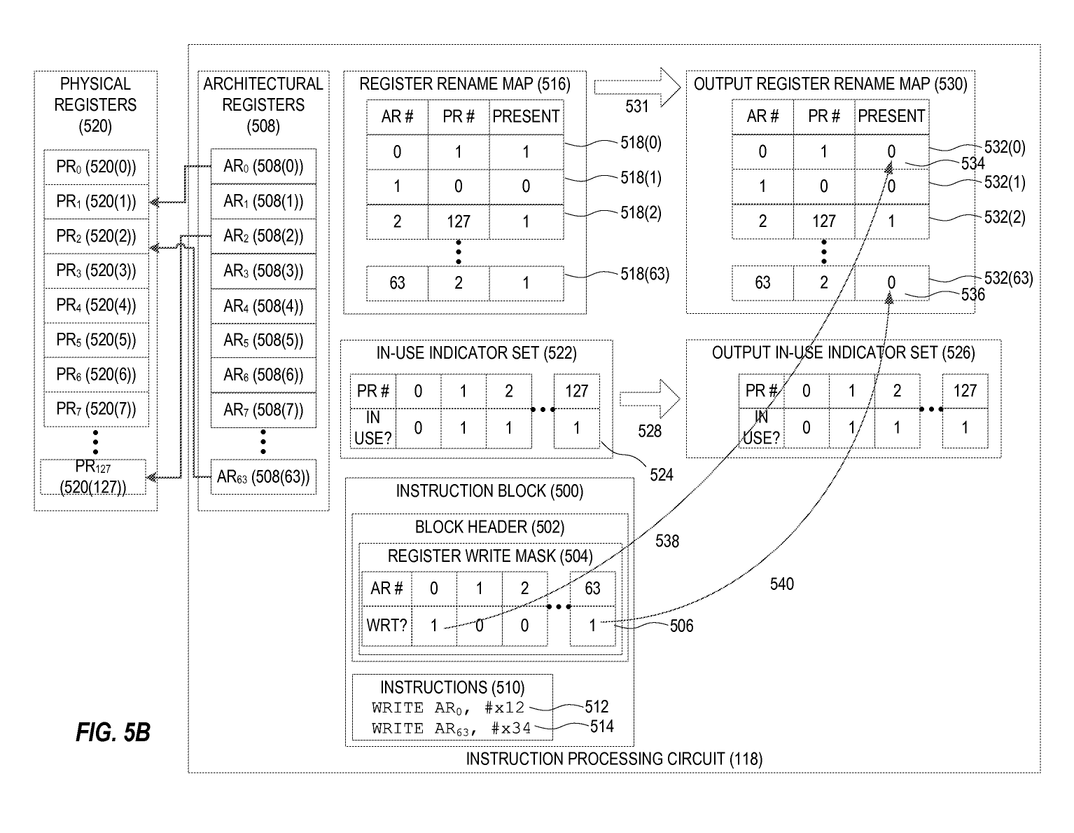

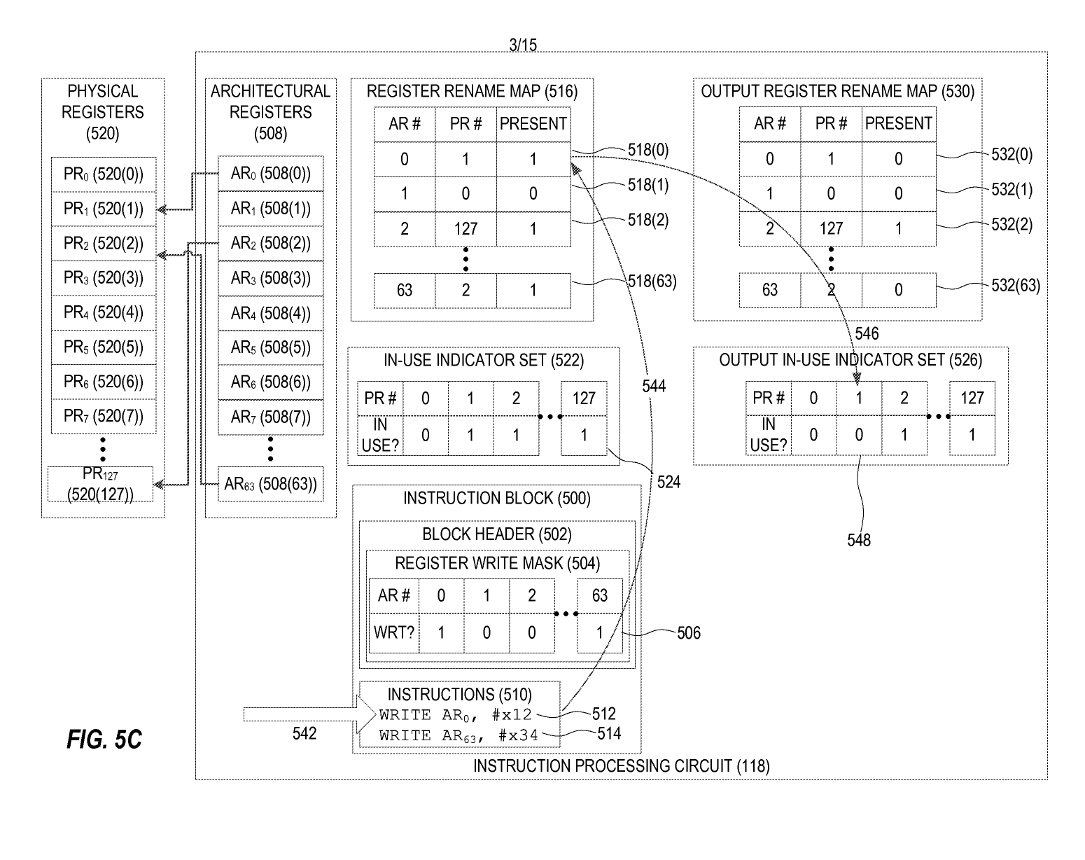

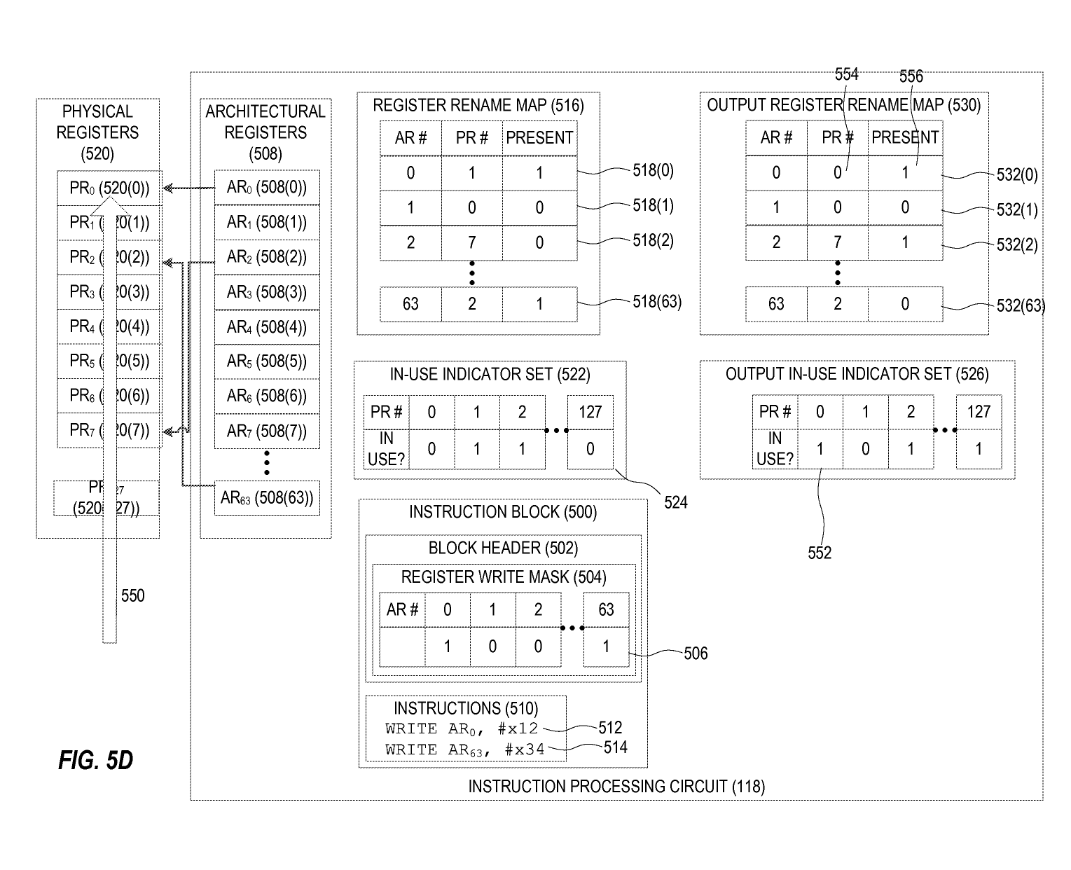

As discussed above, a processor core implementing a block-based ISA may also copy register rename maps as part of operations for managing physical register allocation. In this regard, FIGS. 5A-5D further illustrate additional exemplary communications flows and operations for the instruction processing circuit 118 of FIG. 1 for creating and updating an output register rename map in conjunction with in-use indicator sets. In the example of FIG. 5A, the instruction processing circuit 118 has fetched an instruction block 500, which may correspond to one of the instruction blocks 108(0)-108(X) of FIGS. 1 and 2. The instruction block 500 includes a block header 502 providing a register write mask 504. The register write mask 504 comprises a set of indicator bits 506 each corresponding to one of architectural registers 508(0)-508(63). The set of indicator bits 506 indicates which of the architectural registers 508(0)-508(63) will be written by instructions 510 within the instruction block 500. In this example, the register write mask 504 indicates that architectural registers 508(0) AR₀ and 508(63) AR₆₃ are to be written within the instruction block 500. It is to be understood that, in some aspects, the register write mask 504 indicates expected writes to the architectural registers 508(0)-508(63), and thus may not be binding on the instruction block 500. For instance, an expected write indicated by the register write mask 504 to one of the architectural registers 508(0)-508(63) may fail to occur, resulting in the architectural register 508(0)-508(63) retaining its original value. (i.e., the indicated write may be “annulled”). In this example, the instructions 510 of the instruction block 500 include a WRITE instruction 512 and a WRITE instruction 514.

The instruction block 500 is associated with a register rename map 516 comprising entries 518(0)-518(63), each of which includes an architectural register number (“AR #”), a physical register number (“PR #”), and a present bit (“PRESENT”). The physical register number for each of the entries 518(0)-518(63) indicates one of physical registers 520(0)-520(127) that is currently mapped to one of the architectural registers 508(0)-508(63). The present bit of each of the entries 518(0)-518(63) indicates that the mapping is active and available for use. In the example of FIG. 5A, the entry 518(0) indicates that the architectural register 508(0) (“AR₀”) is presently mapped to physical register 520(1) (“PR₁”). Similarly, the entry 518(2) indicates that the architectural register 508(2) (“AR₂”) is presently mapped to the physical register 520(127) (“PR₁₂₇”), and the entry 518(63) indicates that the architectural register 508(63) (“AR₆₃”) is presently mapped to physical register 520(2) (“PR₂”)

An in-use indicator set 522 is associated with the register rename map 516 of FIG. 5A. The in-use indicator set 522 provides a bit set 524 that represents the current allocation state of the physical registers 520(0)-520(127). In the present example, the bit set 524 indicates that the physical registers PR₁, PR₂, and PR₁₂₇ are presently allocated.

Referring now to FIG. 5B, processing of the instruction block 500 begins. The instruction processing circuit 118 copies the in-use indicator set 522 as an output in-use indicator set 526, as indicated by arrow 528. The instruction processing circuit 118 further copies the register rename map 516 as an output register rename map 530, as indicated by arrow 531. As discussed above with respect to FIG. 2, in some aspects the output in-use indicator set 526 and the output register rename map 530 may be provided later as input to an instruction block (not shown) subsequent to commitment of the instruction block 500. The output register rename map 530 includes entries 532(0)-532(63), each corresponding to a respective one of the architectural registers 508(0)-508(63).

After copying the output register rename map 530, the instruction processing circuit 118 examines the register write mask 504 of the block header 502 of the instruction block 500 to determine which of the architectural registers 508(0)-508(63) are indicated to be written within the instruction block 500. As noted above, the register write mask 504 indicates that architectural registers 508(0) AR₀ and 508(63) AR₆₃ are to be written within the instruction block 500. Accordingly, the instruction processing circuit 118 modifies present indicators 534 and 536 of the entries 532(0) and 532(63) of the output register rename map 530, which correspond to the architectural registers 508(0) and 508(63), to indicate not present, as indicated by arrows 538 and 540. Note that if the expected writes to the architectural registers 508(0) AR₀ and/or 508(63) AR₆₃ do not take place in the instruction block 500 as expected (i.e., the expected writes are annulled), and the output register rename map 530 was merely passed on to a subsequent instruction block as an input register rename map (not shown) with present indicators 534 and/or 536 still indicating not present, then the present indicators 534 and/or 536 and their physical register numbers of the output register rename map 530 may be updated from the input register rename map 516 when the annulment is detected.

In FIG. 5C, the instruction processing circuit 118 detects the WRITE instruction 512 that writes a hexadecimal value of 12 to architectural register 508(0) AR₀, as indicated by arrow 542. The instruction processing circuit 118 then examines the register rename map 516, as indicated by arrow 544, to determine a previous physical register 520(0)-520(127) associated with the architectural register 508(0) AR₀. In the example of FIG. 5C, the entry 518(0) of the register rename map 516 indicates that the previous physical register 520(0)-520(127) associated with the architectural register 508(0) AR₀ is the physical register 520(1) PR₁. Accordingly, as indicated by arrow 546, the instruction processing circuit 118 modifies an indicator 548 corresponding to the previous physical register 520(1) in the output in-use indicator set 526 to have a value of “0” to indicate that the previous physical register 520(1) is unused.

Referring now to FIG. 5D, to complete the write operation of the WRITE instruction 512, the instruction processing circuit 118 may then allocate a new physical register 520(0)-520(127) to the architectural register 508(0) being written to by the WRITE instruction 512. The instruction processing circuit 118 may allocate the new physical register 520(0)-520(127) based on the physical register 520(0)-520(127) allocation state represented by a logical OR (not shown) of the in-use indicator set 522 and the output in-use indicator set 526. As indicated by arrow 550, the instruction processing circuit 118 allocates the physical register 520(0) PR₀ to store the value written to the architectural register 508(0). To accurately reflect the allocation in the output in-use indicator set 526, the instruction processing circuit 118 modifies an indicator 552 corresponding to the allocated physical register 520(0) PR₀ in the output in-use indicator set 526. In this example, the instruction processing circuit 118 sets the indicator 552 to a value of one (“1”) to indicate that the allocated physical register 520(0) is in use.

The instruction processing circuit 118 also updates the output register rename map 530 to reflect the mapping of the architectural register 508(0) AR₀ to the physical register 520(0) PR₀. Accordingly, the instruction processing circuit 118 modifies the entry 532(0) of the output register rename map 530 to indicate an association between the architectural register 508(0) and the allocated physical register 520(0). In particular, the instruction processing circuit 118 sets a physical register number field 554 of the entry 532(0) to a value of zero (“0”) corresponding to the physical register number of the allocated physical register 520(0) PR₀. The instruction processing circuit 118 also modifies a present indicator 556 of the entry 532(0) to indicate a state of “present.”

In some aspects, in addition to updating the output in-use indicator set 526 and the output register rename map 530 of the instruction block 500, the instruction processing circuit 118 also updates output in-use indicator sets and output register rename maps of instructions blocks being processed in sequence after the instruction block 500 to indicate that a previous physical register 520(1) is now unallocated. For instance, assuming the instruction block 500 corresponds to the instruction block 108(0) of FIG. 2, the instruction processing circuit 118 may also update the register rename map 204(X), which serves as the output register rename map for the subsequent instruction block 108(1). The instruction processing circuit 118 additionally may update the in-use indicator set 214(X) representing the output register rename map for the subsequent instruction block 108(1).

Accordingly, the instruction processing circuit 118 may first identify one or more subsequent instruction blocks 108(0)-108(X) among the one or more instruction blocks 108(0)-108(X). The instruction processing circuit 118 may then carry out operations similar to those illustrated in FIGS. 5C and 5D for each subsequent instruction block 108(0)-108(X) identified. For purposes of illustration, assume that the subsequent instruction block 108(1) is to be updated. The instruction processing circuit 118 may first modify an indicator 216(X) corresponding to the previous physical register 520(1) in the output in-use indicator set 214(X) of the subsequent instruction block 108(1) to indicate that the previous physical register 520(1) is unused.

The instruction processing circuit 118 may then examine the register write mask 212(1) for the subsequent instruction block 108(1) to determine whether the architectural register 508(0) is also written in the subsequent instruction block 108(1). If the architectural register 508(0) is not written in the subsequent instruction block 108(1), the instruction processing circuit 118 may update the output register rename map 204(X) of the subsequent instruction block 108(1) to reflect the newly allocated physical register 520(0)-520(127). For example, the instruction processing circuit 118 may modify an entry 206(X) of the one or more entries 206(0)-206(X) of the output register rename map 204(X) of the subsequent instruction block 108(1) to indicate an association between the architectural register 508(0) and the allocated physical register 520(0). The instruction processing circuit 118 may also modify a present indicator 208(X) of the entry 206(X) to indicate a state of “present.”

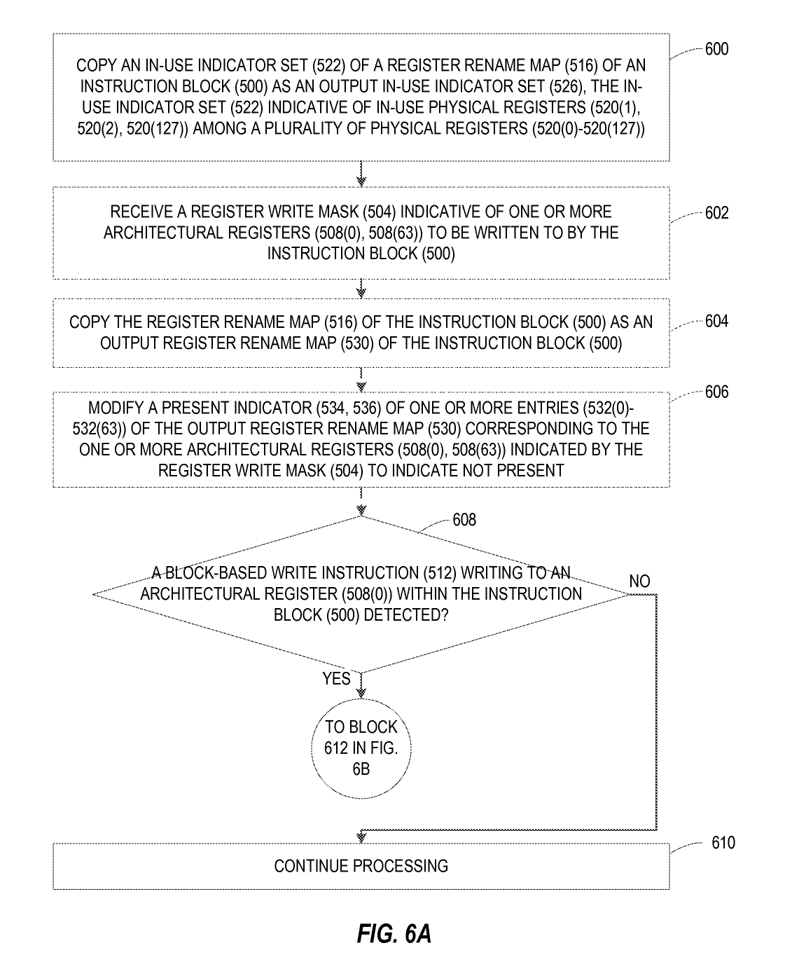

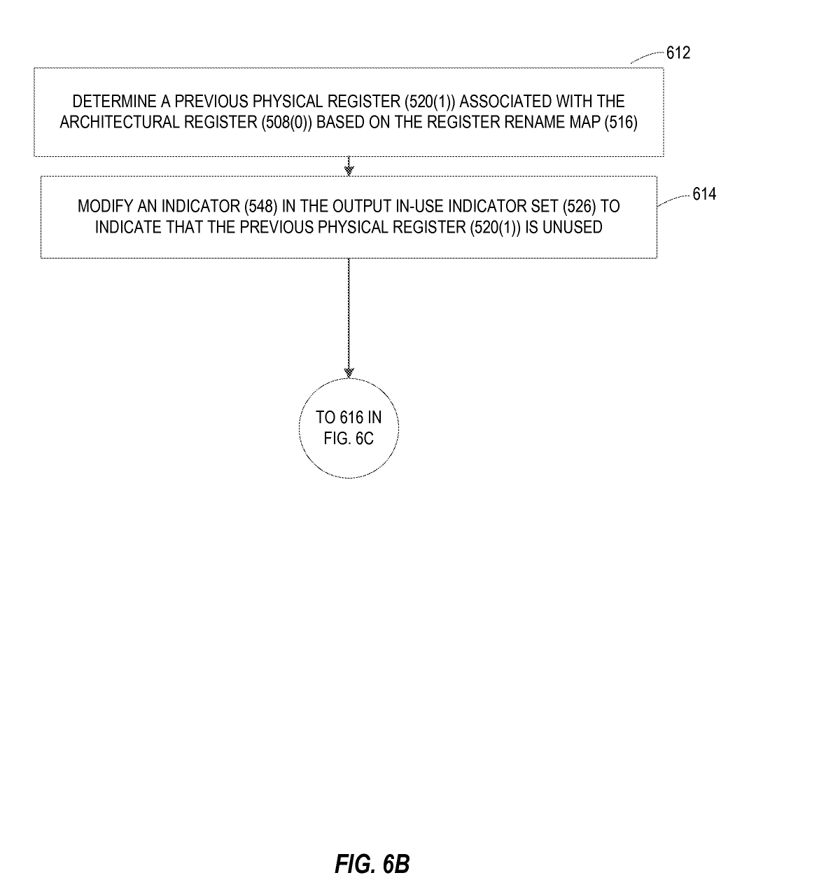

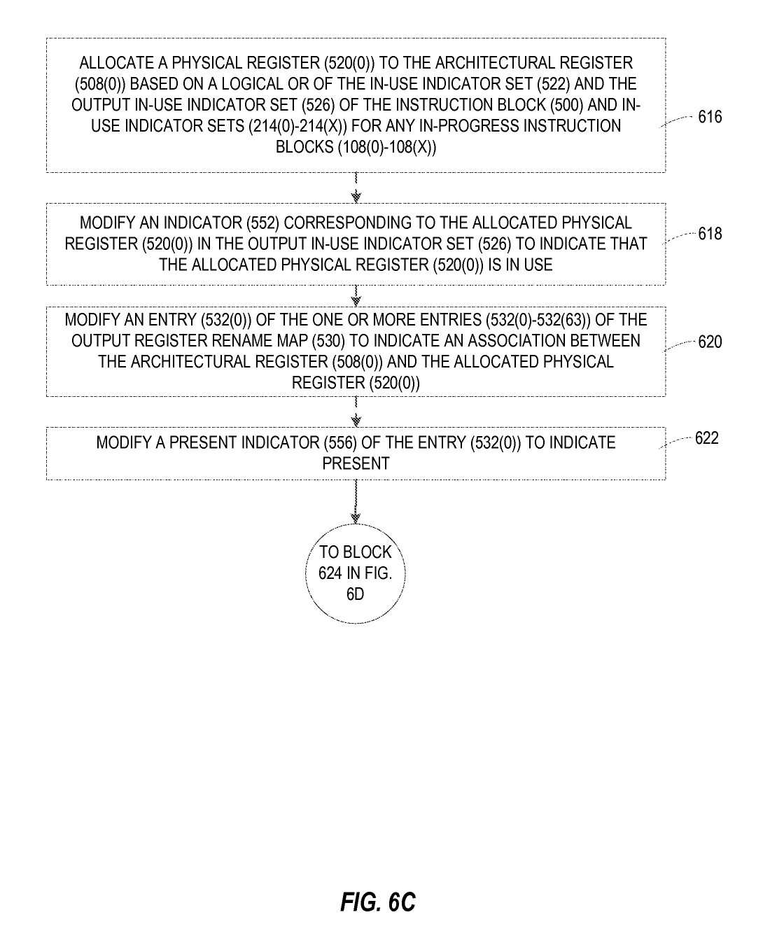

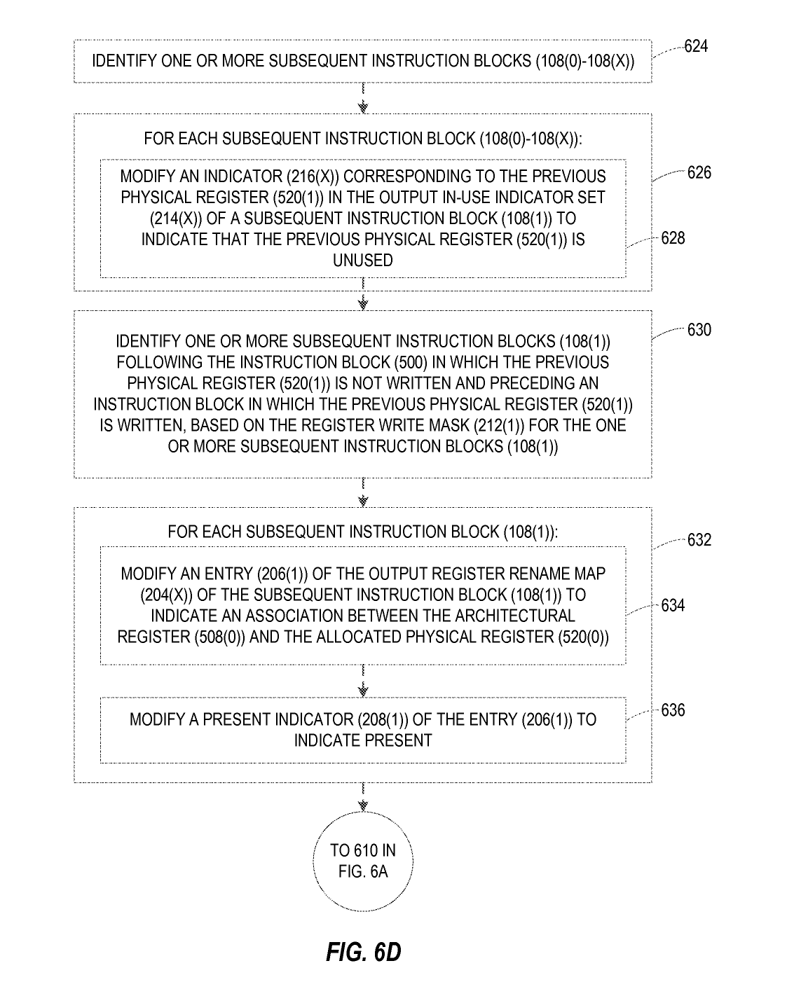

FIGS. 6A-6D are flowcharts illustrating further exemplary operations for managing physical register allocation using an output in-use indicator set in conjunction with an output register rename map. For the sake of clarity, elements of FIGS. 2 and 5A-5D are referenced in describing FIGS. 6A-6D. In some aspects, operations may be carried out by the instruction processing circuit 118 for each instruction block 500 of one or more instruction blocks 108(0)-108(X). Operations begin with the instruction processing circuit 118 copying an in-use indicator set 522 of a register rename map 516 of the instruction block 500 as an output in-use indicator set 526, the in-use indicator set 522 indicative of in-use physical registers 520(1), 520(2), 520(127) among a plurality of physical registers 520(0)-520(127) (block 600). In some aspects, the instruction processing circuit 118 may receive a register write mask 504 indicative of one or more architectural registers 508(0), 508(63) that are to be written by the instruction block 500 (block 602).

Some aspects may provide that the instruction processing circuit 118 then copies the register rename map 516 of the instruction block 500 as an output register rename map 530 of the instruction block 500 (block 604). In such aspects, the instruction processing circuit 118 modifies a present indicator 534, 536 of one or more entries 532(0)-532(63) of the output register rename map 530 corresponding to the one or more architectural registers 508(0), 508(63) indicated by the register write mask 504 to indicate not present (block 606).

The instruction processing circuit 118 next determines whether a write instruction 512 writing to an architectural register 508(0) is detected within the instruction block 500 (block 608). If not, the instruction processing circuit 118 continues processing at block 610 if there are no more instruction blocks 108(0)-108(X) to process. If the write instruction 512 writing to the architectural register 508(0) is detected at decision block 608, processing resumes at block 612 of FIG. 6B.

Referring now to FIG. 6B, the instruction processing circuit 118 determines a previous physical register 520(1) associated with the architectural register 508(0) based on the register rename map 516 (block 612). The instruction processing circuit 118 then modifies an indicator 548 in the output in-use indicator set 526 to indicate that the previous physical register 520(1) is unused (block 614). In this manner, the output in-use indicator set 526 is incrementally updated as write instructions 512, 514 are encountered within the instruction block 500. Processing resumes at block 616 in FIG. 6C.

In FIG. 6C, to complete the write operation initiated by the write instruction 512, some aspects of the instruction processing circuit 118 may allocate a physical register 520(0) of the plurality of physical registers 520(0)-520(127) to the architectural register 508(0) based on the logical OR of the in-use indicator set 522 and the output in-use indicator set 526 of the instruction block 500 and in-use indicator sets 214(0)-214(X) for any in-progress instruction blocks 108(0)-108(X) (block 616). The instruction processing circuit 118 may then modify an indicator 552 corresponding to the allocated physical register 520(0) in the output in-use indicator set 526 to indicate that the allocated physical register 520(0) is in use (block 618). The instruction processing circuit 118 may also modify an entry 532(0) of the one or more entries 532(0)-532(63) of the output register rename map 530 to indicate an association between the architectural register 508(0) and the allocated physical register 520(0) (block 620). A present indicator 556 of the entry 532(0) may be modified to indicate present (block 622). Processing then resumes at block 624 in FIG. 6D.

Referring now to FIG. 6D, the instruction processing circuit 118 in some aspects may identify one or more subsequent instruction blocks 108(0)-108(X) (block 624). Operations may then be carried out for each subsequent instruction block 108(0)-108(X) (block 626). In particular, the instruction processing circuit 118 may modify an indicator 216(X) corresponding to the previous physical register 520(1) in the output in-use indicator set 214(X) of a subsequent instruction block 108(1) to indicate that the previous physical register 520(1) is unused (block 628).

The instruction processing circuit 118 may next identify one or more subsequent instruction blocks 108(1) following the instruction block 500 in which the architectural register 508(0) is not written and preceding an instruction block in which the architectural register 508(0) is written, based on the register write mask 212(1) for the one or more subsequent instruction blocks 108(1) (block 630). The instruction processing circuit 118 may then carry out operations for each subsequent instruction block 108(1) (block 632). In some aspects, the instruction processing circuit 118 may modify an entry 206(1) of the output register rename map 204(X) of the subsequent instruction block 108(1) to indicate an association between the architectural register 508(0) and the allocated physical register 520(0) (block 634). The instruction processing circuit 118 may then modify a present indicator 208(1) of the entry 206(1) to indicate present (block 636). Processing then resumes at block 610 in FIG. 6A after all subsequent instruction blocks 108(0)-108(X) are processed.

Managing allocation of physical registers in a block-based ISA according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

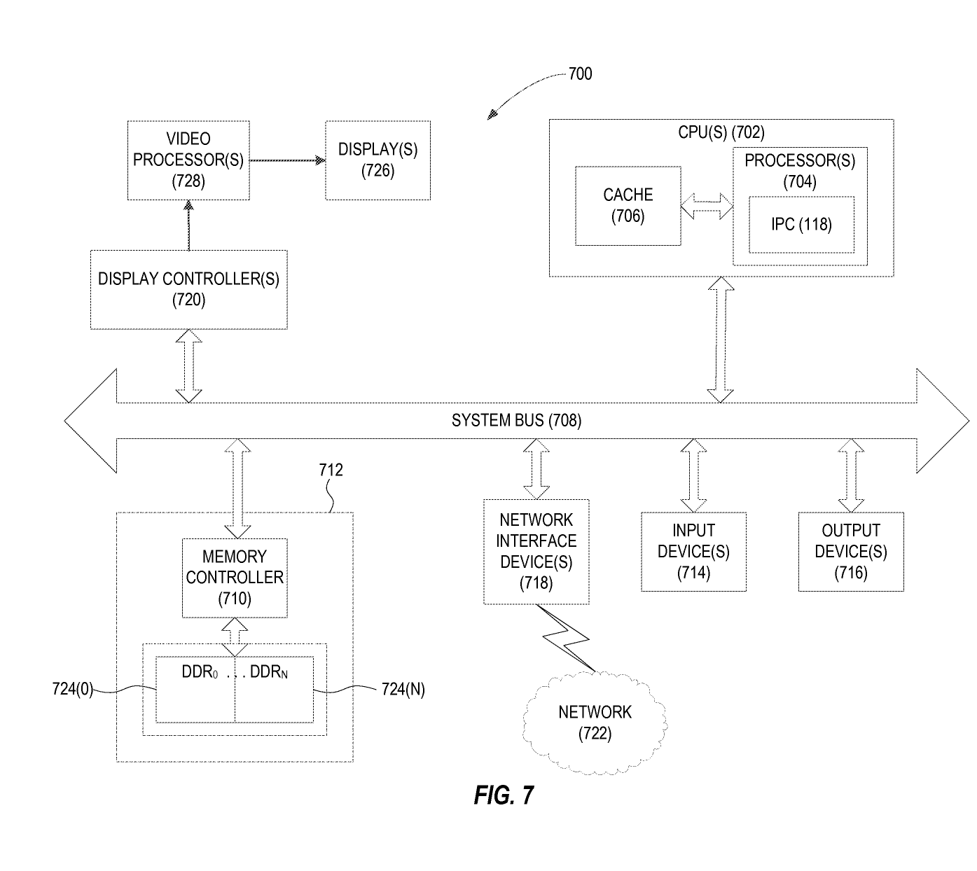

In this regard, FIG. 7 illustrates an example of a processor-based system 700 that can employ the instruction processing circuit 118 illustrated in FIG. 1. In this example, the processor-based system 700 includes one or more central processing units (CPUs) 702, each including one or more processors 704. The one or more processors 704 may include the instruction processing circuit (IPC) 118 of FIG. 1. The CPU(s) 702 may be a master device. The CPU(s) 702 may have cache memory 706 coupled to the processor(s) 704 for rapid access to temporarily stored data. The CPU(s) 702 is coupled to a system bus 708 and can intercouple master and slave devices included in the processor-based system 700. As is well known, the CPU(s) 702 communicates with these other devices by exchanging address, control, and data information over the system bus 708. For example, the CPU(s) 702 can communicate bus transaction requests to a memory controller 710 as an example of a slave device.

Other master and slave devices can be connected to the system bus 708. As illustrated in FIG. 7, these devices can include a memory system 712, one or more input devices 714, one or more output devices 716, one or more network interface devices 718, and one or more display controllers 720, as examples. The input device(s) 714 can include any type of input device, including but not limited to input keys, switches, voice processors, etc. The output device(s) 716 can include any type of output device, including but not limited to audio, video, other visual indicators, etc. The network interface device(s) 718 can be any devices configured to allow exchange of data to and from a network 722. The network 722 can be any type of network, including but not limited to a wired or wireless network, a private or public network, a local area network (LAN), a wide local area network (WLAN), and the Internet. The network interface device(s) 718 can be configured to support any type of communications protocol desired. The memory system 712 can include one or more memory units 724(0-N).

The CPU(s) 702 may also be configured to access the display controller(s) 720 over the system bus 708 to control information sent to one or more displays 726. The display controller(s) 720 sends information to the display(s) 726 to be displayed via one or more video processors 728, which process the information to be displayed into a format suitable for the display(s) 726. The display(s) 726 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, Dynamic RAM (DRAM), Synchronous DRAM (SDRAM), a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sets other than the illustrated sets. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus comprising an instruction processing circuit communicatively coupled to a plurality of physical registers, the instruction processing circuit comprising:
a register rename map of an instruction block, comprising an association between at least one architectural register and at least one of the plurality of physical registers; and
an in-use indicator set associated with the register rename map, the in-use indicator set indicative of an in-use physical register among the plurality of physical registers;
the instruction processing circuit configured to:
copy the in-use indicator set as an output in-use indicator set; and
modify the output in-use indicator set upon detection of a block-based write instruction within the instruction block to mark the in-use physical register as unused.

2. The apparatus of claim 1, wherein:
the instruction processing circuit is further configured to:
detect the block-based write instruction writing to an architectural register within the instruction block; and
determine a previous physical register associated with the architectural register based on the register rename map; and
modify the output in-use indicator set by modifying an indicator in the output in-use indicator set to indicate that the previous physical register is unused.

3. The apparatus of claim 2, wherein the instruction processing circuit is further configured to, responsive to detecting the block-based write instruction writing to the architectural register:
identify one or more subsequent instruction blocks; and
for each subsequent instruction block of the one or more subsequent instruction blocks, modify an indicator in the output in-use indicator set of the subsequent instruction block to indicate that the previous physical register is unused.

4. The apparatus of claim 2, wherein the instruction processing circuit is further configured to receive a register write mask indicative of one or more architectural registers to be written by the instruction block.

5. The apparatus of claim 4, wherein the instruction processing circuit is further configured to receive the register write mask by receiving a block header for the instruction block, the block header comprising the register write mask.

6. The apparatus of claim 4, wherein the instruction processing circuit is further configured to, responsive to detecting the block-based write instruction writing to the architectural register:
allocate a physical register to the architectural register based on a logical OR of the in-use indicator set and the output in-use indicator set of the instruction block and in-use indicator sets for any in-progress instruction blocks; and
modify an indicator corresponding to the allocated physical register in the output in-use indicator set to indicate that the allocated physical register is in use.

7. The apparatus of claim 6, wherein the instruction processing circuit is further configured to:
copy the register rename map of the instruction block as an output register rename map of the instruction block;
modify a present indicator of one or more entries of the output register rename map corresponding to the one or more architectural registers indicated by the register write mask to indicate not present; and
responsive to detecting the block-based write instruction writing to the architectural register:
modify an entry of one or more entries of the output register rename map to indicate an association between the architectural register and the allocated physical register; and
modify a present indicator of the entry to indicate present.

8. The apparatus of claim 7, wherein the instruction processing circuit is further configured to, responsive to detecting the block-based write instruction writing to the architectural register:
identify one or more subsequent instruction blocks following the instruction block in which the architectural register is not written and preceding an instruction block in which the architectural register is written, based on a register write mask for the one or more subsequent instruction blocks; and
for each subsequent instruction block:
modify an entry of one or more entries of the output register rename map of the subsequent instruction block to indicate an association between the architectural register and the allocated physical register; and
modify a present indicator of the entry to indicate present.

9. The apparatus of claim 1 integrated into an integrated circuit (IC).

10. The apparatus of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

11. An apparatus comprising an instruction processing circuit, comprising:
a means for copying an in-use indicator set of a register rename map of an instruction block as an output in-use indicator set, the in-use indicator set indicative of an in-use physical register among a plurality of physical registers; and
a means for modifying the output in-use indicator set upon detection of a block-based write instruction within the instruction block to mark the in-use physical register as unused.

12. The apparatus of claim 11, further comprising:
a means for detecting the block-based write instruction writing to an architectural register within the instruction block; and
a means for determining a previous physical register associated with the architectural register based on the register rename map;
wherein the means for modifying the output in-use indicator set comprises a means for modifying an indicator in the output in-use indicator set to indicate that the previous physical register is unused.

13. The apparatus of claim 12, further comprising:
a means for identifying one or more subsequent instruction blocks, responsive to detecting the block-based write instruction writing to the architectural register; and
a means for modifying an indicator in the output in-use indicator set of each subsequent instruction block to indicate that the previous physical register is unused, responsive to detecting the block-based write instruction writing to the architectural register.

14. The apparatus of claim 12, further comprising a means for receiving a register write mask indicative of one or more architectural registers to be written by the instruction block.

15. The apparatus of claim 14, wherein the means for receiving the register write mask comprises a means for receiving a block header for the instruction block, the block header comprising the register write mask.

16. The apparatus of claim 14, further comprising:
a means for allocating a physical register to the architectural register based on a logical OR of the in-use indicator set and the output in-use indicator set of the instruction block and in-use indicator sets for any in-progress instruction blocks, responsive to detecting the block-based write instruction writing to the architectural register; and
a means for modifying an indicator corresponding to the allocated physical register in the output in-use indicator set to indicate that the allocated physical register is in use, responsive to detecting the block-based write instruction writing to the architectural register.

17. The apparatus of claim 16, further comprising:
a means for copying the register rename map of the instruction block as an output register rename map of the instruction block;
a means for modifying a present indicator of one or more entries of the output register rename map corresponding to the one or more architectural registers indicated by the register write mask to indicate not present;
a means for modifying an entry of one or more entries of the output register rename map to indicate an association between the architectural register and the allocated physical register, further responsive to detecting the block-based write instruction writing to the architectural register; and
a means for modifying a present indicator of the entry to indicate present, further responsive to detecting the block-based write instruction writing to the architectural register.

18. The apparatus of claim 17, further comprising:
a means for identifying one or more subsequent instruction blocks following the instruction block in which the previous physical register is not written and preceding an instruction block in which the previous physical register is written, based on the register write mask for the one or more subsequent instruction blocks and responsive to detecting the block-based write instruction writing to the architectural register;
a means for modifying an entry of one or more entries of the output register rename map of each subsequent instruction block to indicate an association between the architectural register and the allocated physical register, further responsive to detecting the block-based write instruction writing to the architectural register; and
a means for modifying a present indicator of the entry to indicate present, further responsive to detecting the block-based write instruction writing to the architectural register.

19. A method for managing allocation of physical registers in a block-based instruction set architecture (ISA), comprising:
copying an in-use indicator set of a register rename map of an instruction block as an output in-use indicator set, the in-use indicator set indicative of an in-use physical register among a plurality of physical registers; and
modifying the output in-use indicator set upon detection of a block-based write instruction within the instruction block to mark the in-use physical register as unused.

20. The method of claim 19, further comprising:
detecting the block-based write instruction writing to an architectural register within the instruction block; and
determining a previous physical register associated with the architectural register based on the register rename map;
wherein modifying the output in-use indicator set comprises modifying an indicator in the output in-use indicator set to indicate that the previous physical register is unused.

21. The method of claim 20, further comprising, responsive to detecting the block-based write instruction writing to the architectural register:
identifying one or more subsequent instruction blocks; and
for each subsequent instruction block of the one or more subsequent instruction blocks, modifying an indicator in the output in-use indicator set of the subsequent instruction block to indicate that the previous physical register is unused.

22. The method of claim 20, further comprising receiving a register write mask indicative of one or more architectural registers to be written by the instruction block.

23. The method of claim 22, wherein receiving the register write mask comprises receiving a block header for the instruction block, the block header comprising the register write mask.

24. The method of claim 22, further comprising, responsive to detecting the block-based write instruction writing to the architectural register:
allocating a physical register to the architectural register based on a logical OR of the in-use indicator set and the output in-use indicator set of the instruction block and in-use indicator sets for any in-progress instruction blocks; and
modifying an indicator corresponding to the allocated physical register in the output in-use indicator set to indicate that the allocated physical register is in use.

25. The method of claim 24, further comprising:
copying the register rename map of the instruction block as an output register rename map of the instruction block;
modifying a present indicator of one or more entries of the output register rename map corresponding to the one or more architectural registers indicated by the register write mask to indicate not present; and
further responsive to detecting the block-based write instruction writing to the architectural register:
modifying an entry of one or more entries of the output register rename map to indicate an association between the architectural register and the allocated physical register; and
modifying a present indicator of the entry to indicate present.

26. The method of claim 25, further comprising, responsive to detecting the block-based write instruction writing to the architectural register:
identifying one or more subsequent instruction blocks following the instruction block in which the previous physical register is not written and preceding an instruction block in which the previous physical register is written, based on a register write mask for the one or more subsequent instruction blocks; and
for each subsequent instruction block:
modifying an entry of one or more entries of the output register rename map of the subsequent instruction block to indicate an association between the architectural register and the allocated physical register; and
modifying a present indicator of the entry to indicate present.
